(19) United States
(12) Patent Application Publication
(10) Pub. No.: US 2015/0345954 A1
(43) Pub. Date: Dec. 3, 2015

(54) GRAPHICAL ROUTE NAVIGATION

(71) Applicant: AKTIEBOLAGET SKF, Göteborg (SE)

(72) Inventor: Alexander Pinkerton, Aberdeen (GB)

(21) Appl. No.: 14/654,193

(22) PCT Filed: Dec. 17, 2013
(86) PCT No.: PCT/EP2013/076938

§ 371 Date: Jun. 19, 2015

Related U.S. Application Data
(60) Provisional application No. 61/739,086, filed on Dec. 19, 2012.

(51) Int. Cl. G01C 21/20

(52) U.S. Cl. CPC G01C 21/206

(57) ABSTRACT

A graphical route navigation process utilizes a known layout of an environment within a structure in combination with a series of route coordinate reference tags, wherein each second route coordinate reference tag location is available for use as a path coordinate. The process defines a route for directing an individual through the structure. The route can be used for inspecting equipment or other items within the facility. The process is presented in a graphical format on any suitable portable computing device, including tablets, smart phones, and the like. The process can include support functions, including photographical assistance screens, inter-floor transfer assistance screens, and environmental hazard or warning screens. The support device would include a capability to read the reference tags enabling the device to determine the location of the individual within the structure.

### CROSS-REFERENCE TO RELATED APPLICATIONS

This PCT application claims the benefit of co-pending U.S. Provisional Patent Application Ser. No. 61/739,086, filed on Dec. 19, 2012

### BACKGROUND OF THE INVENTION

1. Technical Field

The present invention relates to a process for guiding an individual through an indoor environment. More specifically, the process presents a graphical representation of a route for navigating through an indoor environment and several features providing assistance for guiding the individual accordingly.

2. Background Art

Global Positioning Systems (GPS) provide geographical coordinates and graphical routing guidance to individuals. The GPS utilizes telemetry from satellite signals. The GPS receiver must be in a location capable of receiving the satellite signals. Since the location of the device is determined by triangulation of the satellite signals, the system can't utilize redirected signals. Thus, the GPS receiver is only effective in an environment directly accessible to the satellite signals. The GPS receivers are ineffective in environments where the RF satellite signals are blocked. These areas are quite common, including inside buildings, ships, offshore installations, underground facilities, and the like.

Thus, what is desired is a process for guiding an individual through an indoor environment.

### DISCLOSURE OF THE INVENTION

The present invention is directed to a process and respective device that guides an individual through an environment where RF satellite signals for GPS systems are unavailable.
In a first aspect of the present invention, a process that guides an individual through an environment, the process comprising the steps:
providing a graphical representation of an environment;
identifying a series of reference coordinates within the environment, wherein the series of reference coordinates defines a predetermined route;
installing a machine readable reference marker at each respective reference coordinate within the environment;
reading one of the machine readable reference markers to determine a current location of the individual;

displaying a graphical representation of the location of the individual based upon the location of the specific read machine readable reference marker; and

displaying at least one next movement in accordance with the predetermined route.

In a second aspect of the present invention, the machine readable reference markers are Radio Frequency Identification Devices (RFID).

In another aspect of the present invention, the machine readable reference markers are linear barcode labels.

In another aspect of the present invention, the machine readable reference markers are matrix barcode labels.

In yet another aspect, the process includes a representation of a single floor of an environment.

In yet another aspect, the process includes a representation of multiple floors of an environment.

In yet another aspect, the process includes guidance for changing floors. The guidance can include one or more methods for changing floors, including a stairway, an elevator, an escalator, a ladder, and the like.

In yet another aspect, the process can include photographic images to aid the individual in identifying a target location.

In yet another aspect, the process can include graphical images to identify or convey at least one hazardous area.

In yet another aspect, the process can include graphical images to identify or convey at least one restricted area.

The process for guiding an individual through an environment provides several advantages over the currently available navigation processes. The use of GPS is limited to RF exposed environments, such as outdoors or near windows or openings of buildings. The inventive process provides guidance through an environment where GPS is inoperable. The inventive process provides additional guidance including directions for transferring between floors within the environment. The inventive process provides photographic images to aid in determining a desired next route coordinate.

These and other features, aspects, and advantages of the invention will be further understood and appreciated by those skilled in the art by reference to the following written specification, claims and appended drawings, which follow.

### BRIEF DESCRIPTION OF THE DRAWINGS

For a fuller understanding of the nature of the present invention, reference should be made to the accompanying drawings in which:

FIG. 1 presents a plan view of an exemplary inspection route within an exemplary single floor environment;

FIG. 2 presents a first screen image of an exemplary entry route of the graphical route navigation process;

FIG. 3 presents a second screen image of an exemplary first internal route segment of the graphical route navigation process;

FIG. 4 presents a third screen image of an exemplary second internal route segment of the graphical route navigation process;

FIG. 5 presents a fourth screen image of the graphical route navigation process, the screen image presenting a scenario where the individual is located at an incorrect coordinate position within the environment;

FIG. 6 presents a fifth screen image and an exemplary photographical aid screen image of the graphical route navigation process, the photographical aid screen image presenting a photographic image to aid the individual in locating the proper next coordinate position within the environment;

FIG. 7 presents a sixth screen image of the graphical route navigation process, the screen image presenting an instruction to transfer to a different floor, more specifically, the exemplary image presents an instruction to go up three (3) floors;

FIG. 8 presents a seventh screen image of the graphical route navigation process, the screen image presenting a routing path on a 3rd floor, the screen being display subsequent to the transfer to the 3rd floor;

FIG. 9 presents a seventh screen image and an exemplary floor transfer guide screen image of the graphical route navigation process, the screen image presenting an instruction on how to transfer between floors, more specifically, the exemplary image presents an instruction to go down three (3) floors; and

FIG. 10 presents an eighth screen image and an exemplary hazardous warning and restricted area screen image of the graphical route navigation process, the screen image presenting details of a hazardous warning and restricted area notice.

Like reference numerals refer to like parts throughout the several views of the drawings.

### MODES FOR CARRYING OUT THE INVENTION

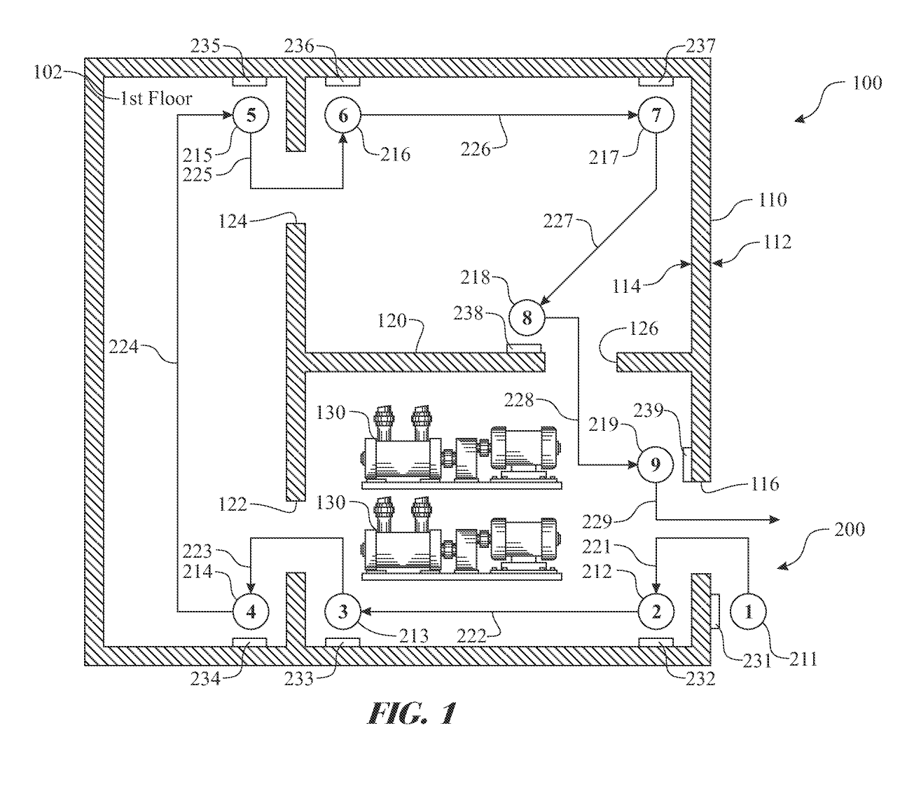

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

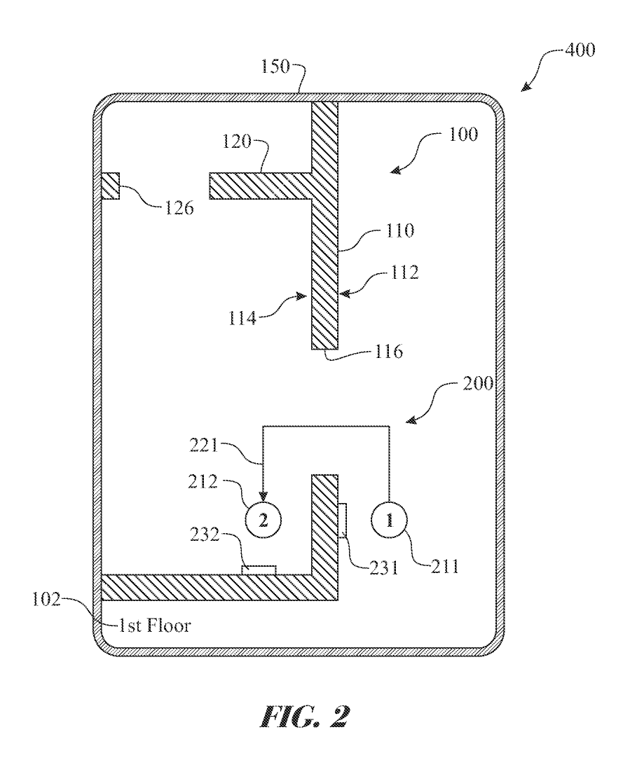

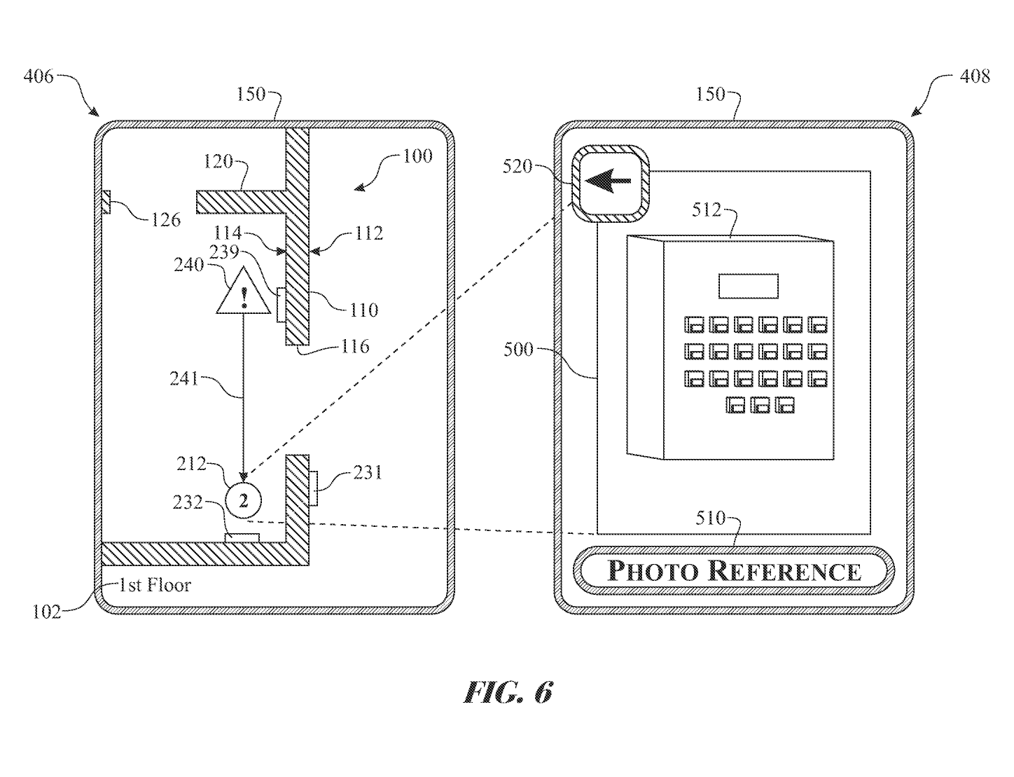

An exemplary first floor facility layout 100 is presented in FIG. 1 for use with an exemplary graphical navigation route process as presented in the exemplary illustrations presented in FIGS. 2 through 10.

The first floor facility layout 100 is representative of a plan of a facility. The facility is defined by a series of facility exterior walls 110 defining a facility exterior 112. A facility exterior wall interior surface 114 of the facility exterior wall 110 defines a peripheral interior surface. At least one facility egress 116 is provided through the facility exterior wall 110, wherein the facility egress 116 provides a passageway for the individual to enter the facility. A series of optional interior walls 120 can be installed within the building and represented in the graphical images. One or more interior passageways 122, 124, 126 can be constructed within the interior walls 120, providing passageways for the individual to traverse between rooms within the facility. The exemplary facility layout includes three (3) interior passageways: a first interior passageway 122, a second interior passageway 124, and a third interior passageway 126. It is understood that the facility layout can include any number of interior walls 120 and respective interior passageways 122, 124, 126. The facility layout can be provided in any architectural arrangement. The exemplary facility layout is of a first floor and identified as such by a first floor reference 102. It is understood that the passageways 116, 122, 124, 126 can be an opening in a wall, a doorway, a bulkhead, and the like.

The facility layout can be used to define a routing pathway, such as an inspection route 200 for an individual. The inspection route 200 would include a series of coordinates arranged along a desired path, wherein the path defines an inspection route for inspecting one or more pieces of equipment (such as exemplary pumps 130), facility locations, and the like. The exemplary inspection route 200 includes a series of nine reference coordinate locations 211, 212, 213, 214, 215, 216, 217, 218, 219. A route segment 221, 222, 223, 224, 225, 226, 227, 228, 229 is provided between each sequential reference coordinate location 211, 212, 213, 214, 215, 216, 217, 218, 219. A coordinate reference tag 231, 232, 233, 234, 235, 236, 237, 238, 239 can be located within the facility proximate each respective reference coordinate location 211, 212, 213, 214, 215, 216, 217, 218, 219. The coordinate reference tag 231, 232, 233, 234, 235, 236, 237, 238, 239 can be located at any suitable location, including along a wall, adjacent to a passageway, adjacent to a doorway, adjacent to a stairway, adjacent to an elevator, adjacent to an escalator, adjacent to a ladder, and the like. The coordinate reference tag 231, 232, 233, 234, 235, 236, 237, 238, 239 can be located adjacent to equipment such as a pump 130, electrical instrumentation, and the like. The coordinate reference tag 231, 232, 233, 234, 235, 236, 237, 238, 239 can also be used to identify the respective floor or level of the facility. The coordinate reference tags 231, 232, 233, 234, 235, 236, 237, 238, 239 are machine readable devices, including linear barcode labels, matrix or 2-dimensional barcode labels, Radio Frequency Identification Devices (RFID), and the like.

Each of the reference coordinate locations 211, 212, 213, 214, 215, 216, 217, 218, 219 along the inspection route 200 could be associated with an inspection point within the facility such as a pump 130, electrical instrumentation, and the like. The operator would use the graphical route navigation device 150 to read the data from each respective coordinate reference tag 231, 232, 233, 234, 235, 236, 237, 238, 239 and record associated inspection data. The graphical route navigation device 150 would direct the operator to the subsequent reference coordinate location 211, 212, 213, 214, 215, 216, 217, 218, 219 upon entry of the associated inspection data at the current reference coordinate location 211, 212, 213, 214, 215, 216, 217, 218, 219. The route can include inspection of equipment, such as pumps 130.

The graphical route navigation would be processed and displayed upon a graphical route navigation device 150. The graphical route navigation process can be provided as an application for any suitable portable computing device including a tablet, a smart phone, and the like. The graphical route navigation process displays a series of screen images 400, 402, 404, 406, 408, 410, 412, 414, 416, 418, 420 presented in the illustrations of FIGS. 2 through 10.

The process would initialize when the operator uses the graphical route navigation device 150 to interface with the initial route coordinate reference tag 231. Upon reading the initial route coordinate reference tag 231, the graphical route navigation device 150 displays a first coordinate screen image 400 as presented in the exemplary illustration of FIG. 2. The first coordinate screen image 400 displays a current location of the individual as an initial route coordinate 211 within an illustrated section of the first floor facility layout 100. A section of the first floor facility layout 100 is displayed within the first coordinate screen image 400 to present a detailed graphical image for clarity to the user. The first coordinate screen image 400 determines the first route segment 221 and displays the first route segment 221 and respective second path coordinate 212. The first route segment 221 directs the individual to proceed to a second path coordinate 212. The individual would subsequently follow the graphically represented first route segment 221 until the individual reaches the second route coordinate reference tag 232. Once the individual arrives at the second route coordinate reference tag 232, the individual uses the graphical route navigation device 150 to read the second route coordinate reference tag 232.

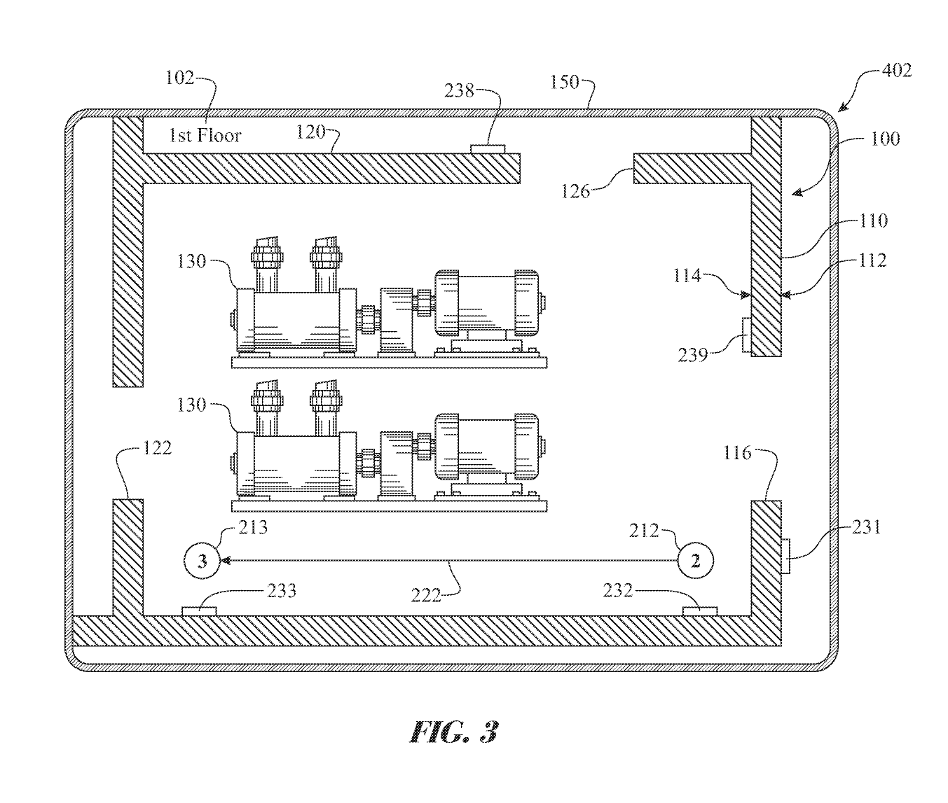

Upon reading the second route coordinate reference tag 232, the graphical route navigation device 150 determines and displays the subsequent route segment, second route segment 222, as illustrated in FIG. 3. A second coordinate screen image 402 displays a revised current location of the individual as a second path coordinate 212 within an illustrated, panned section of the first floor facility layout 100. The second route segment 222 directs the individual to proceed to a third path coordinate 213. The individual would subsequently follow the graphically represented second route segment 222 until the individual reaches the third route coordinate reference tag 233. Once the individual arrives at the third route coordinate reference tag 233, the individual uses the graphical route navigation device 150 to read the third route coordinate reference tag 233.

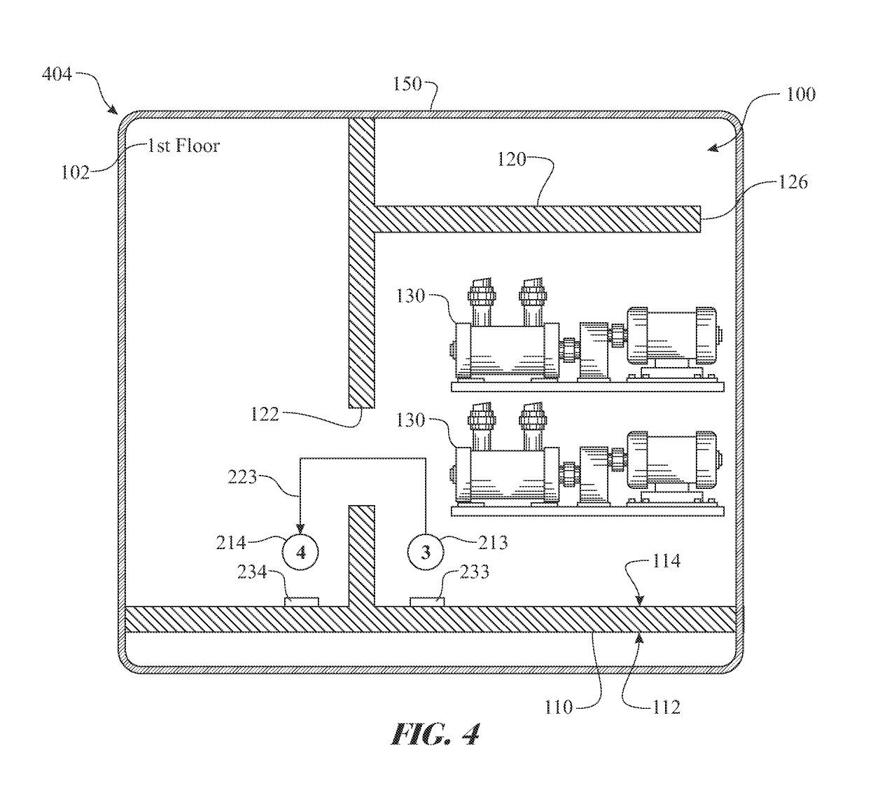

Upon reading the third route coordinate reference tag 233, the graphical route navigation device 150 determines and displays the subsequent route segment, third route segment 223, as illustrated in FIG. 4. A third coordinate screen image 404 displays a revised current location of the individual as a third path coordinate 213 within another illustrated, panned section of the first floor facility layout 100. The third route segment 223 directs the individual to proceed to a fourth path coordinate 214. The individual would subsequently follow the graphically represented third route segment 223 until the individual reaches the forth route coordinate reference tag 234. Once the individual arrives at the forth route coordinate reference tag 234, the individual uses the graphical route navigation device 150 to read the forth route coordinate reference tag 234. It is understood that the process would continue for each of the reference coordinate locations 215, 216, 217, 218, 219 and each respective route segment 225, 226, 227, 228, 229. The individual would use the graphical route navigation device 150 to read each of the respective coordinate reference tag 235, 236, 237, 238, 239.

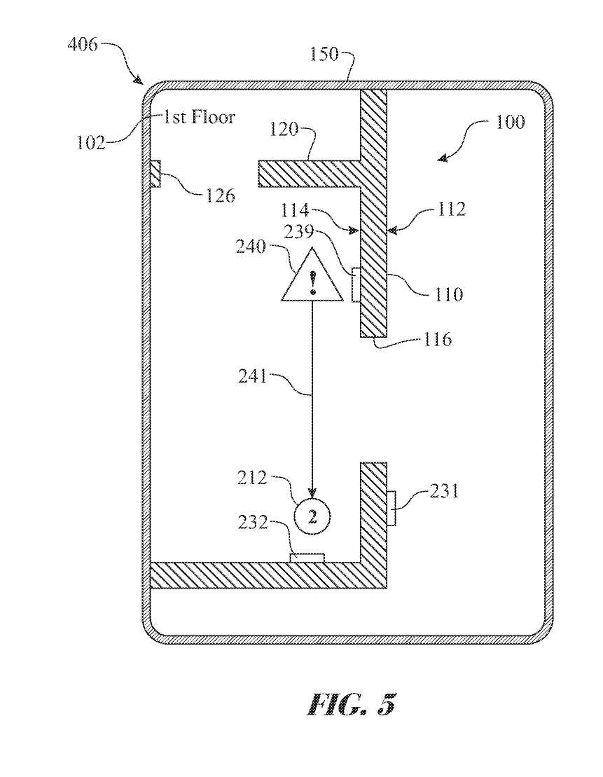

During execution of the process, the operator can encounter any of a variety of scenarios needing assistance. A first exemplary scenario is where the individual traveled off path, ending up at an incorrect location, as illustrated in FIG. 5. When the graphical route navigation device 150 determines that the user is at an incorrect location, the graphical route navigation device 150 displays an incorrect coordinate screen image 406. The incorrect coordinate screen image 406 presents an information icon 240 identifying the current location of the individual. This is determined by reading the coordinate reference tag adjacent to the individual; in the exemplary embodiment, the coordinate reference tag adjacent to the individual is the ninth route coordinate reference tag 239. The graphical route navigation device 150 displays a location correction path 241 providing a proposed path for the individual to follow to the correct reference coordinate location, in the exemplary embodiment, the correct reference coordinate location is the second path coordinate 212. The individual would proceed to the second route coordinate reference tag 232 and use the graphical route navigation device 150 to read the second route coordinate reference tag 232.

Should the individual need assistance in finding the location of the second route coordinate reference tag 232, the user can select the second path coordinate 212 on the screen. The selection of the second path coordinate 212 activates a photographic aid screen image 408. The photographic aid screen image 408 is identified as such by a photographic image reference 510. The photographic aid screen image 408 displays a photographic image 500 comprising one or more distinguishing components within the photographic image 512 to help the individual identify the subsequent coordinates, wherein the exemplary subsequent coordinates are associated with the second path coordinate 212. Upon review of the photographic image 500 and a reasonable confidence for locating the target position within the structure, the user would select the return icon 520 to return to the incorrect coordinate screen image 406.

The facility may include multiple floors. This introduces a new set of issues that need to be addressed. The graphical route navigation device 150 needs to include steps to instruct the individual to change floors. Examples of process steps and respective screen images 410, 412, 414, 416 present several options on steps for instructing the individual to proceed to change floors.

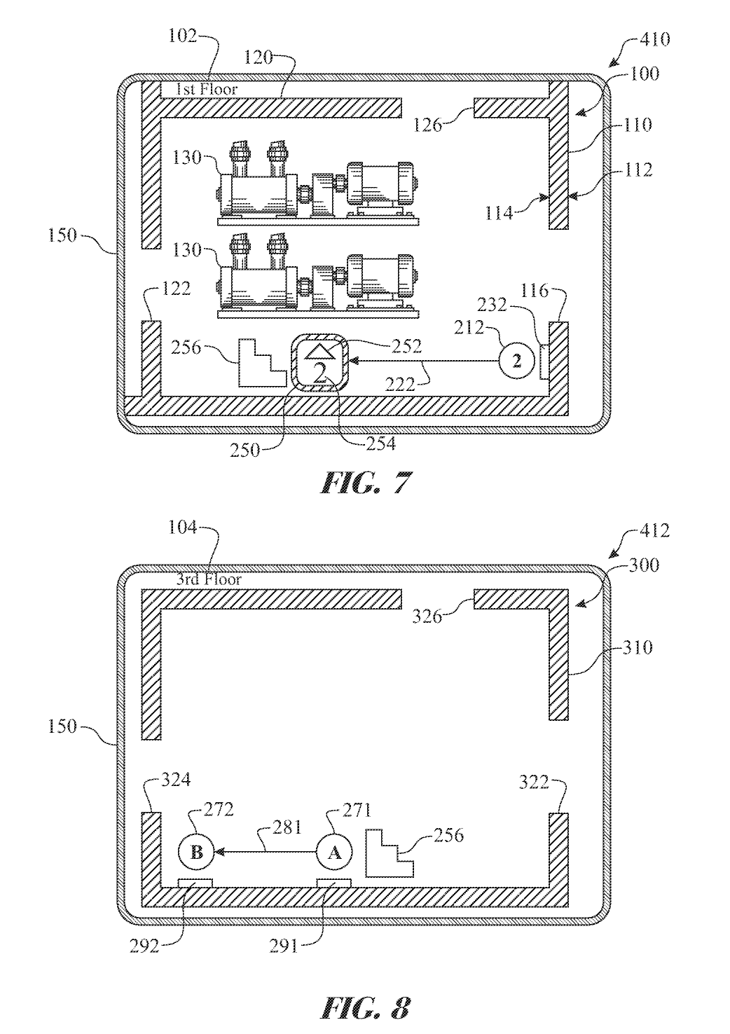

A first example of this scenario is presented in the floor transfer instruction screen 410 displayed in FIG. 7. The individual would be directed to an upward floor transition icon 250. The upward floor transition icon 250 would be linked to a floor transfer multiple instruction screen 416 (FIG. 9) to provide guidance to the individual on how to transfer between floors. In the exemplary embodiment, the floor transfer instruction screen 410 is suggesting the individual use the stairs. The upward floor transition icon 250 can include an indicator of whether the route is directing the individual to go up a predetermined number of floors or down a predetermined number of floors. In the exemplary embodiment, the prescribed direction of travel is identified by an upward indicator 252. The number of floors can be identified by a number of floors identifier 254. The exemplary process directs the user to transfer up two (2) floors, from the first floor to the third floor.

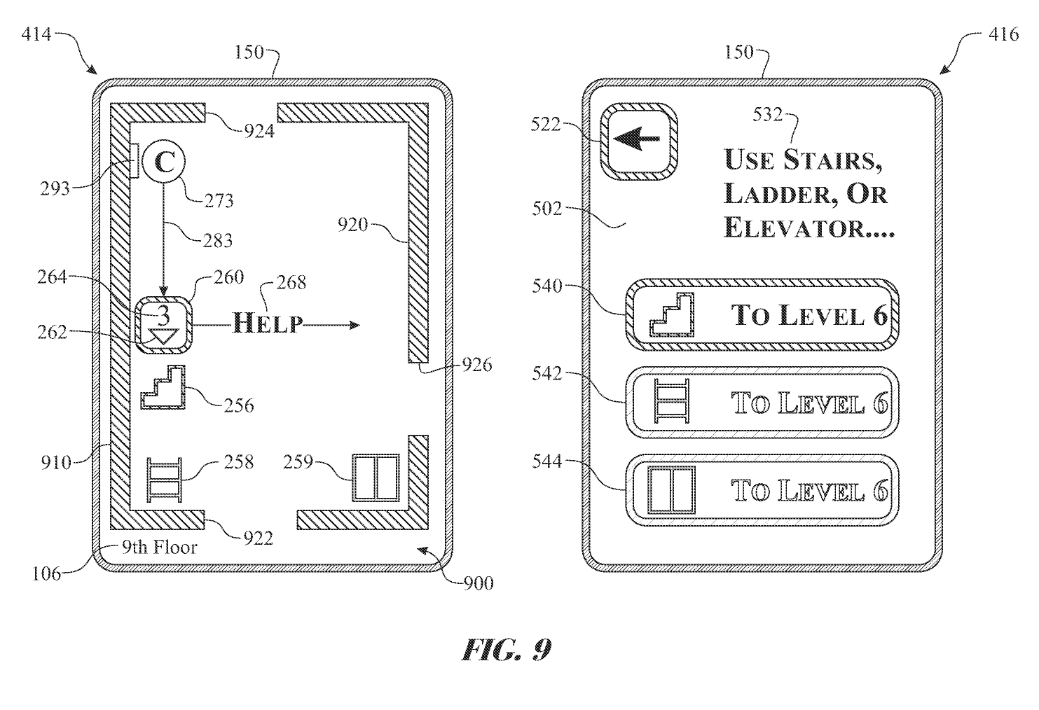

The graphical route navigation device 150 can include a capability of displaying a segment associated with an exemplary route about the exemplary third (3rd) floor layout 300 as displayed in the third floor layout screen image 412, as presented in FIG. 8. The third floor layout screen image 412 preferably includes a floor reference 104 identifying the exemplary layout as being a third floor. The third floor layout 300 includes a facility third floor exemplary wall 310 that defines the structure. The facility third floor exemplary wall 310 is representative of interior and/or exterior walls. A series of passageways 322, 324, 326 provides transitions between rooms. The third floor layout 300 includes a plurality of route coordinate reference tags 292, 292 for aiding the individual in following the predetermined route. The first third floor route coordinate reference tag 291 is located at an arrival point where the individual exits the inter floor transfer apparatus, wherein the exemplary inter floor transfer apparatus is a stairway represented by the stair icon 256. The route is identified by a first third floor coordinate 271. The first third floor coordinate 271 is respective to an initial position located at an arrival point within the third floor layout 300 proximate the first third floor route coordinate reference tag 291. The route provides an instruction to travel from the first third floor coordinate 271 to a second third floor coordinate 272 by way of a first third floor route segment 281. The second third floor coordinate 272 is respective a destination position located within the third floor layout 300 proximate the second third floor route coordinate reference tag 292.

The graphical route navigation device 150 can include a capability of displaying a segment associated with an exemplary route about the exemplary ninth (9th) floor layout 900 as displayed in the ninth floor layout screen image 414, as presented in FIG. 9. The ninth floor layout screen image 414 preferably includes a floor reference 106 identifying the exemplary layout as being a ninth floor. The ninth floor layout 900 includes a facility ninth floor exemplary wall 910 that defines the structure. The facility ninth floor exemplary wall 910 is representative of interior and/or exterior walls. A series of passageways 922, 924, 926 provides transitions between rooms. The graphical route navigation device 150 displays a route 283 includes an instruction directing the individual to travel from a current ninth floor coordinate 273 to a stair icon 256. The ninth floor layout screen image 414 can include a downward floor transition icon 260. The downward floor transition icon 260 includes a downward indicator 262 and a number of floors identifier 264 to inform the individual which direction and the number of floors they are directed to travel. The ninth floor layout screen image 414 can include an optional help reference 268 where the user can select either the downward floor transition icon 260 or the help reference 268 to view the floor transfer multiple instruction screen 416.

The user can select the downward floor transition icon 260, which opens a floor transfer multiple instruction screen 416. The floor transfer multiple instruction screen 416 enables the individual to obtain information respective to alternatives for transport between floors. The floor transfer multiple instruction screen 416 displays a floor transfer instruction selection screen 502 having an instruction summary 532 and a series of available transportation modes 540, 542, 544. The user would select one of the available transportation modes 540, 542, 544, more specifically, a stair transfer instruction icon 540, a ladder transfer instruction icon 542, or a elevator transfer instruction icon 544 to modify the instruction set illustrated in ninth floor layout screen image 414. Once the desired transportation mode 540, 542, 544 is selected, the user contacts a return icon 522 to return to the ninth floor layout screen image 414. The ninth floor layout screen image 414 would display one of the following icons, the stair icon 256, a ladder icon 258, or a elevator icon 259, wherein the displayed icon 256, 258, 259 is respective to the selected transportation mode 540, 542, 544 and update the floor transition route segment 283 accordingly. The inter-floor icon 256, 258, 259 would be displayed in a location representative of the actual location within the respective floor. It is understood that the inter-floor transportation options presented in the floor transfer multiple instruction screen 416 would include any available option, including stairs, ladders, elevators, escalators, poles, and the like. The instruction summary 532 would present a summary of available the inter-floor transportation options.

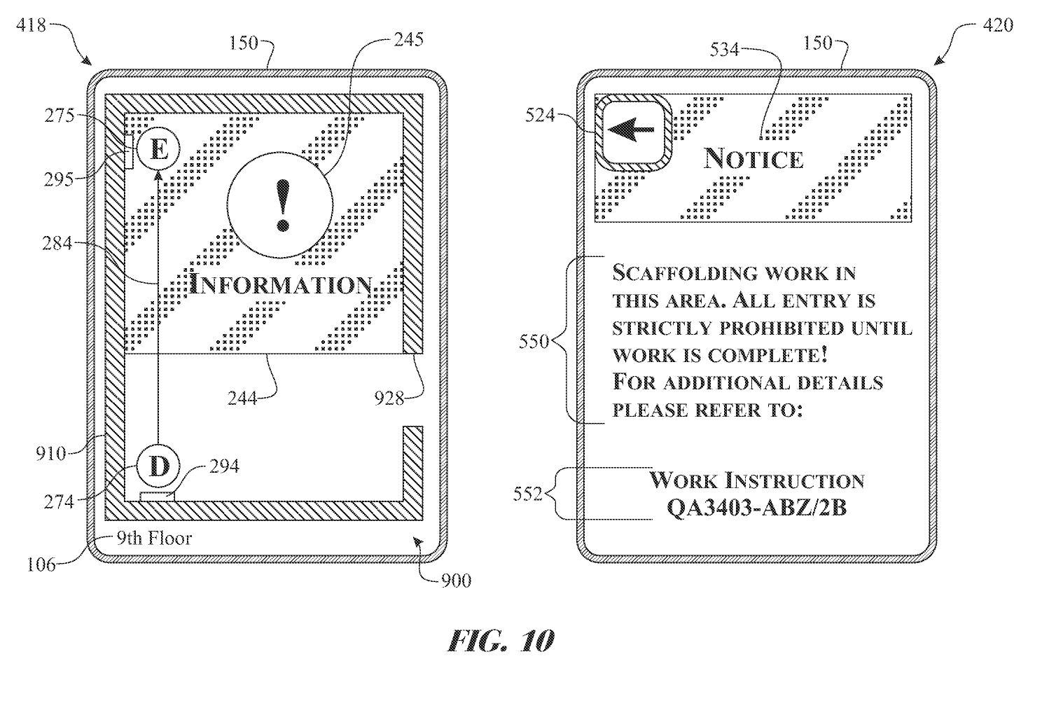

The graphical route navigation device 150 can include a capability of displaying a warning associated with an exemplary route about the exemplary ninth (9th) floor layout 900 as displayed in the warning layout screen image 418, as presented in FIG. 10. The warning layout screen image 418 displays an alternative, panned section of the exemplary ninth floor layout 900 comprising a facility ninth floor exemplary wall 910 comprising a fourth passageway 928. The exemplary warning layout screen image 418 directs the individual to travel from a current individual coordinate 274 to a proposed target coordinate 275, wherein the proposed target coordinate 275 is associated with a fourth ninth floor route coordinate reference tag 295. The user would register the graphical route navigation device 150 with a third ninth floor route coordinate reference tag 294, which locates the individual at the respective position within the ninth floor layout 900. The graphical route navigation device 150 would display a floor transition route segment 284, directing the individual to travel to a proposed target coordinate 275. The exemplary screen image identifies a restricted area identifier 244 within the area of the ninth floor layout 900. An information icon 245 provides a link where, when activates, the graphical route navigation device 150 displays a warning information screen image 420. The warning information screen image 420 presents information associated with the restricted area identifier 244. The warning information screen image 420 can include a warning information screen header 534, warning information details 550, and a warning information reference identifier 552. Once the user has finished reviewing the warning information screen image 420, the user can select a return icon 524 to return to the warning layout screen image 418. The user can elect to travel to the proposed target coordinate 275 after reviewing the information provided in the warning information screen image 420. The warning layout screen image 418 can include a request for an alternative route to avoid the restricted area identifier 244.

In addition to determining the location of the individual within the structure, the process can additionally record the time where each route coordinate reference tag 231, 232, 233, 234, 235, 236, 237, 238, 239 is read by the graphical route navigation device 150.

It is understood that the embodiments presented herein are exemplary in nature and that the specific processes presented by the graphical route navigation device 150 would be designed about a specific application. The information including the photographic aids, the inter-floor transportation modes, the warnings and restricted area notifications, and the like would be tailored to the actual environment.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

| Ref. No. | Description |
|---|---|
| 100 | first floor facility layout |
| 102 | first floor reference |
| 104 | third floor reference |
| 106 | ninth floor reference |
| 110 | facility exterior wall |
| 112 | facility exterior |
| 114 | facility exterior wall interior surface |
| 116 | facility egress |
| 120 | interior wall |
| 122 | first interior passageway |
| 124 | second interior passageway |
| 126 | third interior passageway |
| 130 | pump |
| 150 | graphical route navigation device |
| 200 | inspection route |
| 211 | initial route coordinate |
| 212 | second path coordinate |
| 213 | third path coordinate |
| 214 | fourth path coordinate |
| 215 | fifth path coordinate |
| 216 | sixth path coordinate |
| 217 | seventh path coordinate |
| 218 | eighth path coordinate |
| 219 | ninth path coordinate |
| 221 | first route segment |
| 222 | second route segment |
| 223 | third route segment |
| 224 | fourth route segment |
| 225 | fifth route segment |
| 226 | sixth route segment |
| 227 | seventh route segment |
| 228 | eighth route segment |
| 229 | ninth route segment |
| 231 | initial route coordinate reference tag |
| 232 | second route coordinate reference tag |
| 233 | third route coordinate reference tag |
| 234 | forth route coordinate reference tag |
| 235 | fifth route coordinate reference tag |
| 236 | sixth route coordinate reference tag |
| 237 | seventh route coordinate reference tag |
| 238 | eighth route coordinate reference tag |
| 239 | ninth route coordinate reference tag |
| 240 | information icon |
| 241 | location correction path |
| 244 | restricted area identifier |
| 245 | information icon |
| 250 | upward floor transition icon |
| 252 | upward indicator check |
| 254 | number of floors identifier |
| 256 | stair icon |
| 258 | ladder icon |
| 259 | elevator icon |
| 260 | downward floor transition icon |
| 262 | downward indicator |
| 264 | number of floors identifier |
| 268 | help reference |
| 271 | first third floor coordinate |
| 272 | second third floor coordinate |
| 273 | current ninth floor coordinate |
| 274 | current individual coordinate |
| 275 | proposed target coordinate |
| 281 | first third floor route segment |
| 283 | floor transition route segment |
| 284 | floor transition route segment |
| 291 | first third floor route coordinate reference tag |
| 292 | second third floor route coordinate reference tag |
| 294 | third ninth floor route coordinate reference tag |
| 295 | fourth ninth floor route coordinate reference tag |
| 300 | third floor layout |
| 310 | facility third floor exemplary wall |
| 322 | first interior passageway |
| 324 | second interior passageway |
| 326 | third interior passageway |
| 400 | first coordinate screen image |
| 402 | second coordinate screen image |
| 404 | third coordinate screen image |
| 406 | incorrect coordinate screen image |
| 408 | photographic aid screen image |
| 410 | floor transfer instruction screen |
| 412 | third floor layout screen image |
| 414 | ninth floor layout screen image |
| 416 | floor transfer multiple instruction screen |
| 418 | warning layout screen image |
| 420 | warning information screen image |
| 500 | photographic image |
| 502 | floor transfer instruction selection screen |
| 510 | photographic image reference |
| 512 | distinguishing components within the photographic image |
| 520 | return icon |
| 522 | return icon |
| 524 | return icon |
| 532 | instruction summary |
| 534 | warning information screen header |
| 540 | stair transfer instruction icon |
| 542 | ladder transfer instruction icon |
| 544 | elevator transfer instruction icon |
| 550 | warning information details |
| 552 | warning information reference identifier |
| 900 | ninth floor layout |
| 910 | facility ninth floor exemplary wall |
| 922 | first passageway |
| 924 | second passageway |
| 926 | third passageway |
| 928 | fourth passageway |

What is claimed is:

1. A process that guides an individual through an environment, the process comprising the steps:
providing a graphical representation of an environment on a portable computing device;
identifying a series of reference coordinates within the environment, wherein the series of reference coordinates defines a predetermined route;
installing a machine readable reference marker at each respective reference coordinate within the environment;
reading one of the machine readable reference markers to determine a current location of the individual;
displaying a graphical representation of the location of the individual based upon the location of the specific read machine readable reference marker; and
displaying at least one next movement in accordance with the predetermined route.

2. A process that guides an individual through an environment as recited in claim 1, the method further comprising a step of:
recording data respective to at least one machine readable reference marker.

3. A process that guides an individual through an environment as recited in claim 1, the method further comprising a step of:
recording data respective to each machine readable reference marker.

4. A process that guides an individual through an environment as recited in claim 1, the method further comprising a step of:
recording inspection data respective to an inspected item associated with at least one machine readable reference marker.

5. A process that guides an individual through an environment as recited in claim 1, the method further comprising a step of:
providing directional assistance for vertical transitioning between floors, wherein said vertical direction assistance provides guidance for at least one of upward transition and downward transition and a respective number of floors.

6. A process that guides an individual through an environment as recited in claim 5, the method further comprising a step of:
providing guidance respective to a recommended apparatus for vertical transitioning between floors.

7. A process that guides an individual through an environment as recited in claim 1, the method further comprising a step of:
providing directional assistance by selecting an information icon, which displays a photographic aid screen image comprising a photographic image having at least one distinguishing component.

8. A process that guides an individual through an environment, the process comprising the steps:
providing a graphical representation of an environment on a portable computing device;
identifying a series of reference coordinates within the environment, wherein the series of reference coordinates defines a predetermined route, wherein said predetermined route includes a requirement for completion of at least one task at one of at least one said reference coordinates;
installing a machine readable reference marker at each respective reference coordinate within the environment;
reading one of the machine readable reference markers to determine a current location of the individual;
displaying a graphical representation of the location of the individual based upon the location of the specific read machine readable reference marker;
displaying at least one next movement in accordance with the predetermined route
traveling along said predetermined route; and
recording inspection data respective to said at least one task associated with said at least one machine readable reference marker associated with said respective reference coordinate.

9. A process that guides an individual through an environment as recited in claim 8, the method further comprising a step of:
recording data respective to each machine readable reference marker.

10. A process that guides an individual through an environment as recited in claim 8, the method further comprising a step of:
obtaining data from said machine readable reference marker, wherein said machine readable reference marker is one of:
a Radio Frequency Identification Device (RFID),
a linear barcode label, and
a matrix barcode label.

11. A process that guides an individual through an environment as recited in claim 8, the method further comprising a step of:
recording inspection data respective to an inspected item associated with at least one machine readable reference marker.

12. A process that guides an individual through an environment as recited in claim 8, the method further comprising a step of:
providing directional assistance for vertical transitioning between floors, wherein said vertical direction assistance provides guidance for at least one of upward transition and downward transition and a respective number of floors.

13. A process that guides an individual through an environment as recited in claim 12, the method further comprising a step of:
providing guidance respective to a recommended apparatus for vertical transitioning between floors.

14. A process that guides an individual through an environment as recited in claim 8, the method further comprising a step of:
providing directional assistance by selecting an information icon, which displays a photographic aid screen image comprising a photographic image having at least one distinguishing component.

15. A process that guides an individual through an environment, the process comprising the steps:
providing a graphical representation of an environment on a portable computing device;
identifying a series of reference coordinates within the environment, wherein the series of reference coordinates defines a predetermined route;
installing a machine readable reference marker at each respective reference coordinate within the environment;
reading one of the machine readable reference markers to determine a current location of the individual;
displaying a graphical representation of the location of the individual based upon the location of the specific read machine readable reference marker;
displaying at least one next movement in accordance with the predetermined route
traveling along said predetermined route; and
recording communication data respective to each machine readable reference marker associated with said respective reference coordinate when an individual is at said reference coordinate.

16. A process that guides an individual through an environment as recited in claim 15, the method further comprising a step of:
obtaining data from said machine readable reference marker, wherein said machine readable reference marker is one of:
a Radio Frequency Identification Device (RFID),
a linear barcode label, and
a matrix barcode label.

17. A process that guides an individual through an environment as recited in claim 15, the method further comprising a step of:
recording inspection data respective to an inspected item associated with at least one machine readable reference marker.

18. A process that guides an individual through an environment as recited in claim 15, the method further comprising a step of:
providing directional assistance for vertical transitioning between floors, wherein said vertical direction assistance provides guidance for at least one of upward transition and downward transition and a respective number of floors.

19. A process that guides an individual through an environment as recited in claim 18, the method further comprising a step of:
providing guidance respective to a recommended apparatus for vertical transitioning between floors.

20. A process that guides an individual through an environment as recited in claim 15, the method further comprising a step of:
providing directional assistance by selecting an information icon, which displays a photographic aid screen image comprising a photographic image having at least one distinguishing component.
